(19) United States
(12) Patent Application Publication
(10) Pub. No.: US 2015/0207661 A1
(43) Pub. Date: Jul. 23, 2015

(54) SYSTEM AND METHOD FOR PROVIDING PRIORITY BASED ACCESS TO RESOURCES FOR APPLICATIONS

(71) Applicants: Shreevallabha N. Kulkarni, Bangalore (IN); Rajesh Doyijode, Bangalore (IN); Thomas Hornung, Sarnen (CH)

(72) Inventors: Shreevallabha N. Kulkarni, Bangalore (IN); Rajesh Doyijode, Bangalore (IN); Thomas Hornung, Sarnen (CH)

(73) Assignee: SONIM TECHNOLOGIES, INC., San Mateo, CA (US)

(21) Appl. No.: 14/162,321

(22) Filed: Jan. 23, 2014

(51) Int. Cl. H04L 12/24; H04L 12/26

(52) U.S. Cl. CPC H04L 41/02; H04L 43/08

(57) ABSTRACT

A method and system for providing an enterprise grade runtime on communication devices, for priority based application management. The system provides priority based resource access for applications that are registered as enterprise applications. The system further performs a priority based resource utilization wherein selected resources are monitored and managed to ensure optimum resource utilization. The system also ensures that selected enterprise applications are always ON.

### TECHNICAL FIELD

The embodiments herein relate to application management in communication devices and, more particularly, to provide priority based application management in the communication devices.

### BACKGROUND

With the evolution of communication technology there has been a tremendous improvement in the user devices (such as smart phones, tablet computers, and so on) which are implemented in this field. These user devices offer various features to the users such as touch sensitive interface, online applications and so on. In addition to these functionalities, they offer multitasking capabilities. As the capabilities of these user devices increase, the amount of resources required to achieve these capabilities also increase. Further, there may be scenarios wherein a conflict arises for employing the resources while using different applications simultaneously. As a result, the reliability and performance of these devices may be affected.

‘Mobile phones’ can be considered as best example for such type of user devices. Mobile phones these days are available in different forms and offer a wide variety of service to the users. Most of the mobile phones are designed so as to make them user friendly and customized as per the user's requirements. An example of evolution in the mobile phone is the smart phone. Smart phone offers various features to the users such as multitasking; touch sensitive interface, mobile applications, mobile commerce, and front camera and so on. As the capabilities of the mobile phone increase, the amount of resources required to achieve these functionalities also increase. Further, while using different applications simultaneously, there may be scenarios wherein a conflict arises for employing the resources available. As a result, the reliability and performance of the mobile phone is affected.

In an example, considering the scenario of an enterprise. In the enterprise environment there may be several applications of requirement to the employee for his access. The enterprise may also prefer their employees to support the applications which are required for the enterprise on their user devices (such as mobile phones, tablets and so on). Most of the present day user devices no matter offer the facility of supporting the applications however; they have no means to ensure that the resources required by these applications are provided with a priority.

For example, say an enterprise application requires usage of some megabytes of memory. On the other hand, other applications and functionalities that are residing on the user device may already be consuming a lot of memory space. As a result of this, the amount of memory space required for the enterprise application may not be available. Further, there is no mechanism in these user devices currently to provide a priority to the enterprise application and reserve some memory space for it. In another example, consider an enterprise application requires usage of audio at an instant of time. In such a scenario, if there is already some audio file running on the audio player on the employee's user device there is no means to exit that audio application and provide priority to the enterprise application to play audio.

There are emerging solutions for enterprise Bring Your Own Device (BYOD) where the user devices can be reconfigured with virtualization environment equivalent to Personal Computer's (PC's). This virtualization environment provides a virtual Operating Systems (OS) environment for enterprise applications. This setup provides a ‘restricted enterprise applications only’ environment (i.e., only the enterprise can manage the applications in the virtualized product). However, this is an expensive and complicated method in terms of development and deployment. Such modifications require extensive tests to ensure stability of the core system. It has overheads in terms of creating emulation environment as a preliminary layer on top of which the virtualization engine emulates an enterprise OS environment.

Further, most of the enterprises or industries provide security options for their applications which ensure that the required amount of security is entrusted with the application. However, these applications do not provide the privilege or priority to the applications to access the desired resources as and when required. Further, to support the priority options the user devices may require some modifications in their architectures.

Due to the aforementioned reasons it is evident that user devices such as but not limited to smart phones, tablets and so on that are capable of deciding the priority of applications and accordingly providing access to resources are required. Further, these devices must be capable of supporting the enterprise requirements by incorporating the required parameters as per their performance standards.

### SUMMARY

In view of the foregoing, an embodiment herein provides a method for ensuring reliability of execution environment for a plurality of applications in a communication device. The method comprises of registering the plurality of applications as enterprise applications. Further, priority value is assigned for each of the plurality of enterprise applications, wherein the priority value is indicative of criticality of at least one identified resource in the communication device in comparison with other enterprise applications requiring the at least one resource. Further, each of the plurality of enterprise applications are managed based on the assigned priority value.

Embodiments further disclose a system for ensuring reliability of execution environment for a plurality of applications in a communication device. The system configured for registering the plurality of applications as enterprise applications using an enterprise grade run time system. Further, the system assigns priority value for each of the plurality of enterprise applications using the enterprise grade run time system, wherein the priority value is indicative of criticality of at least one identified resource in the communication device in comparison with other enterprise applications requiring the at least one resource. Further, the system manages each of the plurality of enterprise applications based on the assigned priority value, using the enterprise grade run time system.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of a user device having an enterprise grade runtime system, as disclosed in the embodiments herein;

FIG. 2 is a block diagram that shows various components of an enterprise grade runtime system, as disclosed in the embodiments herein;

FIG. 3 is a block diagram that shows various components of enterprise application management module, as disclosed in the embodiments herein;

FIG. 4 is a block diagram that illustrates system architecture of enterprise grade runtime environment, as disclosed here in the embodiment herein;

FIG. 5 is a flow diagram which shows various steps involved in the process of application management using enterprise grade runtime environment, as disclosed in the embodiments herein;

FIGS. 6A and 6B are flow diagrams which show various steps involved in the process of providing priority based resource access to enterprise applications, as disclosed in the embodiments herein;

FIG. 7 is a flow diagram which shows various steps involved in the process of providing enterprise grade runtime access to an enterprise application, as disclosed in the embodiments herein;

FIG. 8 is a flow diagram which shows various steps involved in the process of providing priority based resource utilization to enterprise applications, as disclosed in the embodiments herein; and

FIG. 9 is a flow diagram which shows various steps involved in the process of ensuring selected enterprise applications are always ON, as disclosed in the embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

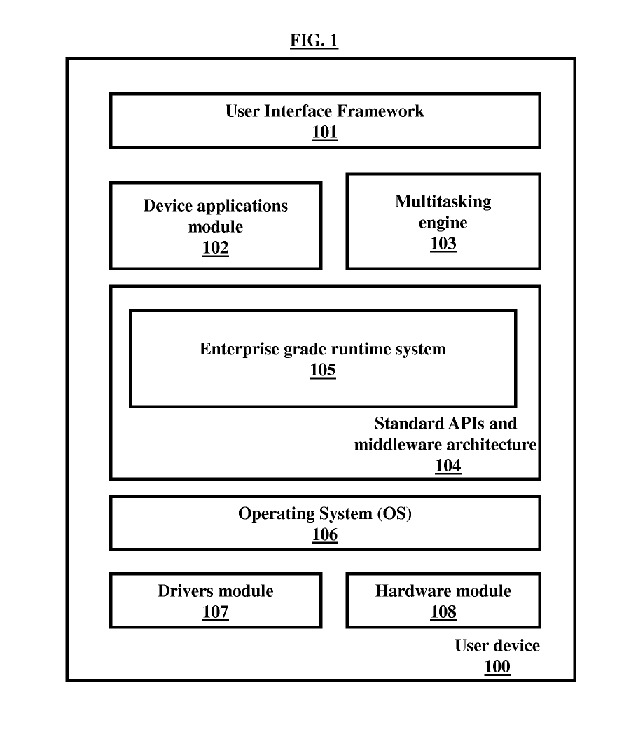

The embodiments herein disclose a system and method of ensuring a reliable runtime environment for enterprise class applications by providing priority based application management on communication devices such as smart phones, tablets and so on by using an enterprise grade runtime access system. It is to be noted that for illustration purpose, the method is explained considering an enterprise application and an enterprise grade runtime environment. However, the specification do not limit scope of proposed method and system to an enterprise level applications and can be extended to use with any network and/or application that possesses specifications that are required by the proposed system and method. Referring now to the drawings, and more particularly to FIGS. 1 through 9, where similar reference characters denote corresponding features consistently throughout the figures, there are shown embodiments.

FIG. 1 illustrates a block diagram of a user device having an enterprise grade runtime system, as disclosed in the embodiments herein. The depicted figure is the architecture of a classical user device 100 with integrated enterprise grade runtime system comprises of a user interface framework 101, a device application module 102, a multitasking engine 103, standard Application Program Interfaces (API) and middleware architecture 104 which further comprises of an enterprise grade runtime system 105, an Operating System (OS) 106, a drivers module 107 and a hardware 108. In an embodiment, the user device 100 can be any handheld computing device which is used for communication purpose such as but not limited to mobile devices (smart phones), tablet computers, smart navigation devices, laptops and smart watches. The user interface framework 101 provides required interfaces to the users in order to interact with the user device 100. The operating system 106 provides all the services that are required to control the execution of the programs such as starting and running the installed applications in the user device 100. The device application module 102 contains all the applications that are installed in the user device 100. The standard APIs and middleware architecture 104 provides an application framework on which applications can be developed as per requirements. The multitasking engine 103 makes the user device 100 capable of accessing different applications simultaneously. Further, the driver module 107 and hardware 108 provides necessary drivers and hard ware required for normal functionality of the user device 100. Furthermore, in order to make the user device 100 capable of deciding priority of the applications and accordingly providing access to resources required, the enterprise grade runtime system 105 is integrated (during manufacturing stage of the user device 100) in the standard APIs and middleware architecture 104 of the user device 100 by providing necessary additional framework elements, modules or APIs.

In case of an enterprise, employees or workers (i.e., users) tend to work outdoors and make use of the user devices 100 such as mobile devices, tablet computers and so on (provided by the enterprise) for their enterprise requirements. In an embodiment, the enterprises can deploy applications suitable for their requirements on these user devices 100. Due to the nature of enterprise outdoor usage, the applications that present in the user devices 100 must meet certain requirements of the enterprise.

The enterprise requirements may be classified as follows:

a) Reliability of performance—This implies that the applications must work all the time being able to perform the user actions and stay connected to the network for repeated operations over a considerable period of time.
b) Precision of performance—This implies that data acquisition such as GPS or from any sensors is highly precise for the usability of such information in the deployed environment.
c) Usability performance—This implies that the field users can perform the required operations within required times and experience quick responsiveness from the application.

Further, the enterprise grade runtime system 105 can make the user device 100 to meet these requirements by deciding priority of the applications to run and accordingly providing access to resources required in the user device 100.

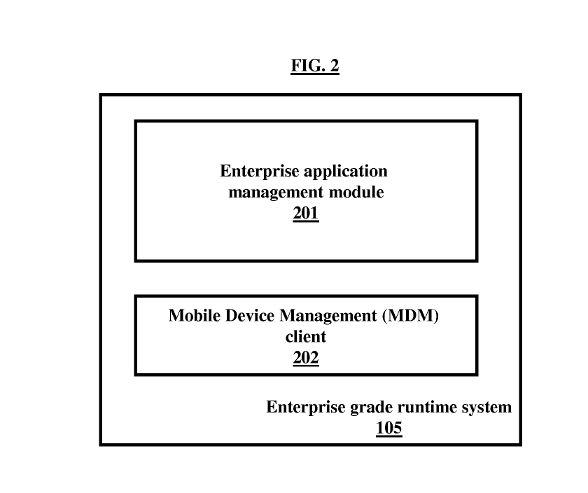

FIG. 2 is a block diagram that shows various components of an enterprise grade runtime system, as disclosed in the embodiments herein. The enterprise grade runtime system 105 comprises of an enterprise application management module 201 and a Mobile Device Management (MDM) client 202.

The enterprise application management module 201 resides in the standard APIs and middleware architecture 104 present in the user device 100 and provides services that are required by the enterprise grade runtime system 105. The enterprise application management services may be a daemon or services which run at power-on of the user device 100. The enterprise application management module 201 authenticates and registers any application that is launched using privilege of the enterprise grade runtime system 105. Moreover, the enterprise application management module 201 keeps track of all the application requests and their priorities and guarantees preferential access to all required resources by managing the priority of preferences between multiple enterprise applications.

The Mobile Device Management (MDM) client 202 present in the enterprise grade runtime system 105 of the user device 100 receives message from a Mobile Device Management server 401 (which is present at a remote location in an enterprise grade runtime environment 400) using a secured path while registering or de-registering an application in the enterprise grade runtime system 105. Further, the MDM client 202 in turn relays this message to the enterprise application management module 201. This message can be used by the enterprise application management module 201 to register or de-register particular applications as privileged application and to set privileges in the enterprise grade runtime system 105.

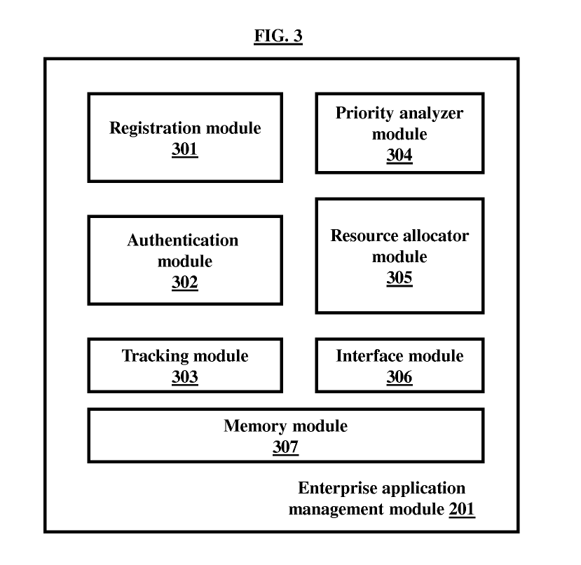

FIG. 3 is a block diagram that shows various components of enterprise application management module, as disclosed in the embodiments herein. The enterprise application management module 201 comprises a registration module 301, an authentication module 302, a tracking module 303, a priority analyzer module 304, a resource allocator module 305, an interface module 306 and a memory module 307.

The registration module 301 provides the necessary requirements to register the applications as enterprise applications in the enterprise application management module 201. Moreover, the registration module 301 maintains a registry database in the memory module 307 which may contain the details of privileges (such as but not limited to specific rules and policies, resources required, Identity) that are provided to the application while registering it as the enterprise application. The authentication module 302 of the enterprise application management module 201 registers the applications securely by providing suitable authentication mechanisms while registering the applications as the enterprise applications. In an embodiment, the interface module 306 provides necessary input and output interfaces required by user to register the applications.

The tracking module 303 prepares a list of resources available for each of the enterprise application while managing the execution of enterprise applications in the enterprise grade run time environment 400. Initially, the tracking module 303 tracks the resource information (i.e., resources required for execution of each of the enterprise application) from the registry database present in the memory module 307. Further, a ‘resource availability list’ is prepared by the tracking module 201 by using the tracked resource information. In an embodiment, ‘tracking’ can be done by comparing the requested application ID with that of the list of ID's that are present in the registry database. In a preferred embodiment, the ‘resource availability list’ may contain the details of all the resources available for a particular application and their availability, the details regarding the applications which are currently using these resources.

TABLE 1

| | | Application using the |
|---|---|---|
| Resources required | Availability | resource currently |
| Audio port | No | Media player |
| GPS connectivity | Yes | — |
| Memory | No | Unprivileged apps (say ‘x’) |

Table 1 shows an example ‘resource availability list’ for a particular enterprise application (say ‘X’). Table 1 shows that for the execution of the enterprise application ‘X’, three resources are required (i.e., audio port, GPS connectivity and memory). Among the three required resources, ‘audio port’ and ‘memory’ are not available to the application ‘X’ as they are currently used by other applications. The tracking module 303 continuously monitors and measures the resource utilization of applications in the user device 100. In an embodiment, the tracking module 303 may use device task manager to monitor and measure the resources utilization. Further, the tracking module 303 identifies the enterprise applications which must run continuously by checking whether the application is in ‘always on’ mode or not. Furthermore, the tracking module 303 continuously checks the ON/OFF status of the enterprise applications which must run always in the user device 100.

While managing the execution of the enterprise applications, the priority analyzer module 304 analyzes the priority of the enterprise application by comparing the priority value of the application with that of the other applications and provides an analysis report to the resource allocator module 305. In an embodiment, the priority analyzer module 304 prepares analysis report based on the pre-configured rules and policies, and priority values that are fetched from the memory module 307. In order to provide sufficient resource access for the enterprise applications, the priority analyzer module 304 compares the resource utilization value with the pre-configured threshold value and makes decision on optimum usage of resources in the enterprise grade runtime environment 400.

The resource allocator module 305 free the resources required for the enterprise applications and allocate them to corresponding enterprise application, based on the data in the analysis report provided by the priority analyzer module 304. Freeing resources may involve pausing or terminating the applications which are currently using the resources.

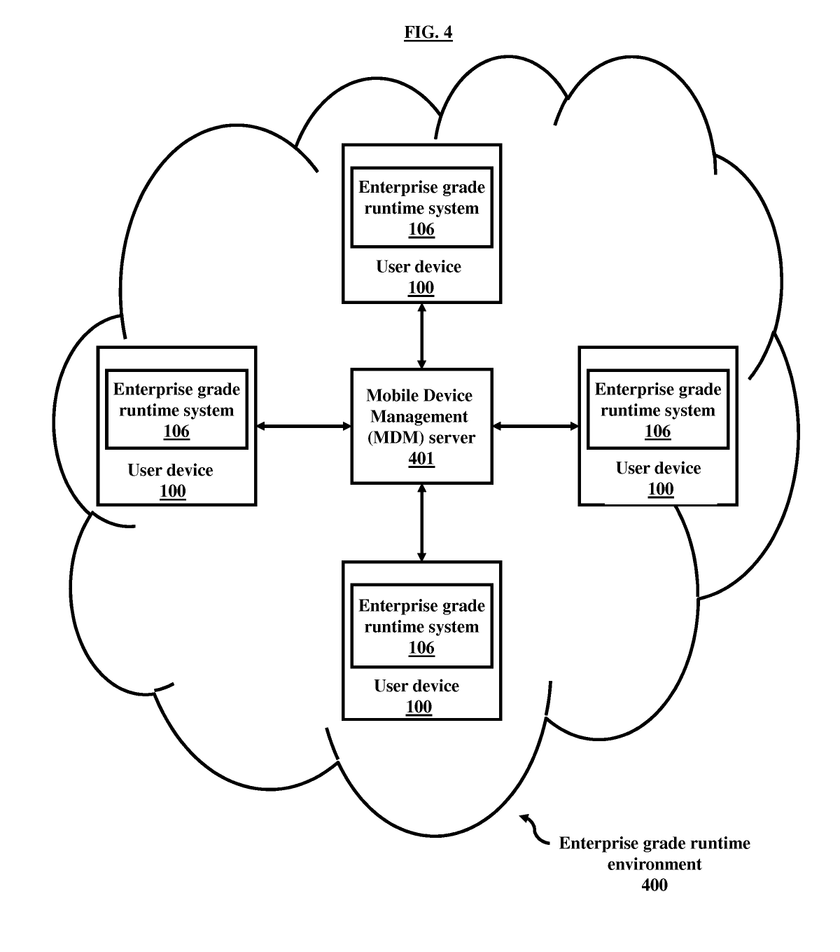

FIG. 4 is a block diagram that illustrates system architecture of enterprise grade runtime environment, as disclosed here in the embodiment herein. The enterprise grade runtime environment 400 comprises a Mobile Device Management (MDM) server 401 and a plurality of user devices 100. The user devices 100 further comprises of an enterprise grade runtime system 106 which manages the execution of enterprise applications present in it. In an embodiment, the MDM server 401 which resides remotely in the enterprise grade runtime environment 400 may act as a source through the device applications can be registered as the enterprise applications. The MDM server 401 can be remotely connected to the user device 100 by using any suitable communication channel between them. For the networks other than enterprise networks, the registration can be done by using suitable sources such as but not limited to an application store, direct internet depending on the type of environment where the applications are used. Further, the MDM server 401 sends message over secure channels to the enterprise grade runtime system 105 of the user devices 100 through the standard APIs and middleware architecture 104 enabling an implicit trust between the MDM client 202 and the MDM server 401. These messages may include the priority value, rules and policies that are required to set a particular application as an enterprise application. Once the applications are registered as enterprise applications, the enterprise grade runtime system 106 manages the execution of the enterprise applications based on the assigned priority values.

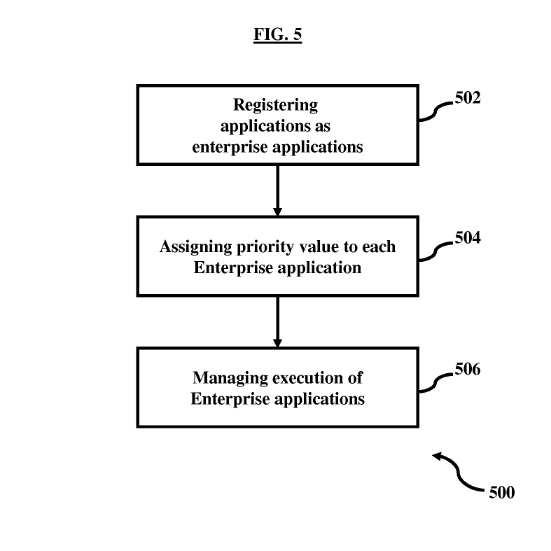

FIG. 5 is a flow diagram which shows various steps involved in the process of application management using enterprise grade runtime environment, as disclosed in the embodiments herein. In order to ensure proper functioning of applications or to manage the execution of applications in the user device 100, the applications should be registered (502) as an ‘enterprise application’ in the enterprise application management module 201 through the registration module 301. In an embodiment, the registration module 301 provides necessary options for any authorized user to register an application as an ‘enterprise application’. There are two ways in which an application can be registered as an enterprise application.

1) Static Method:

In this method, the applications can be registered as ‘enterprise applications’ while installing them in the user device 100. Initially, the privileges that are needed by an application are to be enumerated in the standard files that are available in the OS installation package of the user device 100. In an embodiment, ‘privileges’ refer to rules and policies that are to be provided for accessing particular application in the user device 100. For example, in an ‘Android application installer package’, privileges can be enumerated in the ‘application manifest file’ as it is a standard file in android application. Later, a list of resources that are used by the applications should be entered into the registered database along with a unique identity (ID) number associated with each registered application through the registration module 301.

Table 2 shows a part of an example registry database in the memory module 307, in which 1, 2, 3 defines the unique identity number of applications X, Y, Z respectively. Moreover, the application X uses the recourses A, B, C while the applications Y and Z uses the resources D, E and F, G, H respectively.

TABLE 2

| Unique ID | Application name | Resources required |
|---|---|---|
| 1 | X | A, B, C |
| 2 | Y | D, E |
| 3 | Z | F, G, H |

The tracking module 303 may use the above registry database to identify the resources required for a particular enterprise application. In a preferred embodiment, the tracking module 303 can dynamically identify the resources required for running an enterprise application by using any suitable mechanism. For example, the interface module 306 may provides necessary user interfaces to dynamically add the resources required for executing a particular enterprise application in the enterprise grade runtime system environment 400.

After enumerating privileges in the standard files, the authenticating module 302 installs the applications in the enterprise grade run time system 105 by authenticating the applications securely. In an embodiment, the authentication can be done by associating a ‘binary signature’ with the applications. Further, the ‘binary signature’ may be created by generating a ‘binary hash value’ (Ha). Later, the binary hash value is encrypted by using a public key (PuK) provided by the enterprise grade runtime system 105. Let us assume the encrypted hash value as (He).

When an application is installed, the authentication module 302 of the Enterprise application management module 201 authenticates the application by generating a hash value (Hb) using the binary (which is used in generating encrypted hash value (He)) again. Later, the authentication module 302 decrypts the encrypted Hash (He) using a private key (PrK) in order to get a decrypted hash value (Hd). In an embodiment, the private key (Prk) is pre-configured with the memory module 307 of the Enterprise application management module 201 through the MDM server 401. Finally, the authentication module 302 compares the decrypted hash value (Hd) and the generated hash value (Hb) and checks whether both the values are same or not. If both the values are equal, the registration module 301 registers the application as the ‘enterprise application’ in a registry database of the memory module 307.

2) Dynamic Method:

The applications which are already installed in the user device 100 can be dynamically registered as the enterprise applications in the enterprise application management module 201. This can be done by using the Mobile Device Management (MDM) server 401 which is located remotely in the enterprise grade runtime environment 400. The MDM client 202 in the enterprise grade runtime system 105 receives message from the MDM server 401 to set a particular application as an enterprise application. The MDM client 202 in turn relays this message to the enterprise application management module 201 through the interface module 306. Finally, the enterprise application management module 201 registers that particular application as the enterprise application by updating its registry database in the memory module 307. In an embodiment, a similar verification which is used in the static method can also be done while registering the installed applications in the registry of the memory module 307.

After registering the application as an enterprise application, priority value (i.e., the level of criticality) of each of the registered application should be decided in order to manage the execution of the applications in the Enterprise grade runtime environment. This value can be assigned (504) to each of the enterprise application through the interface module 306 of the enterprise application management module 201. In an embodiment, the priority values may be given as ‘high’ or ‘medium’ or ‘low’ depending on the importance given to each of the enterprise application. For example, if the application is very important, ‘high’ priority can be assigned. Once the priority value is assigned to the enterprise applications, the enterprise application management module 201 manages (506) the execution of these applications based on the assigned priority values. In another embodiment, managing the execution of enterprise applications includes services such as but not limited to providing priority based resource access, providing priority based resource utilization and ensuring selected enterprise applications are always ON.

The various actions in method 500 may be performed in the order presented, in a different order or simultaneously. Further, in some embodiments, some actions listed in FIG. 5 may be omitted.

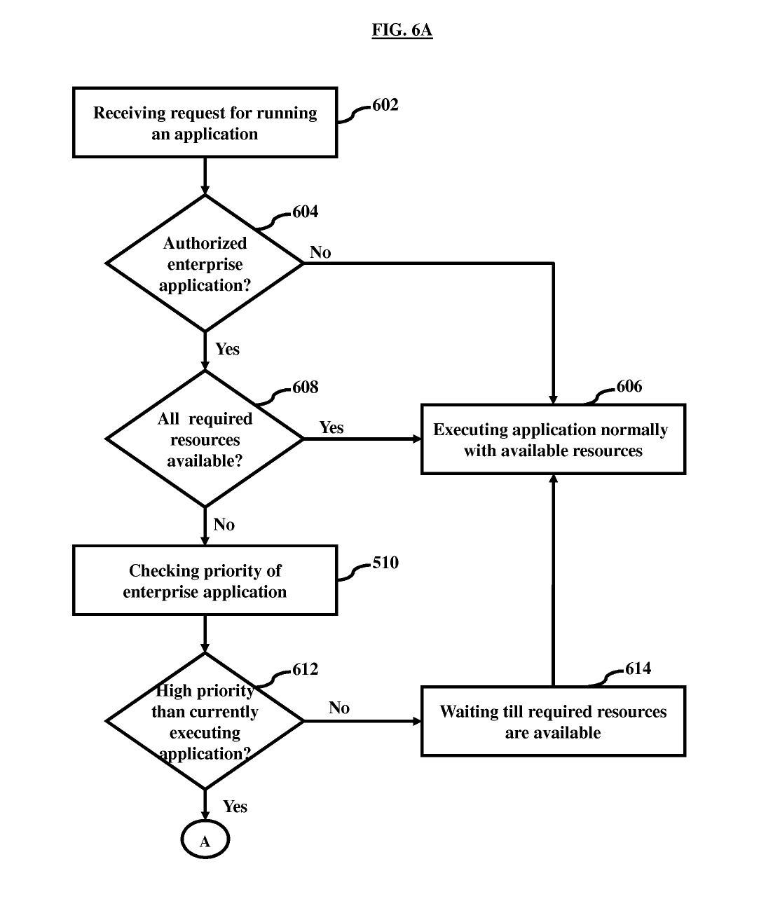

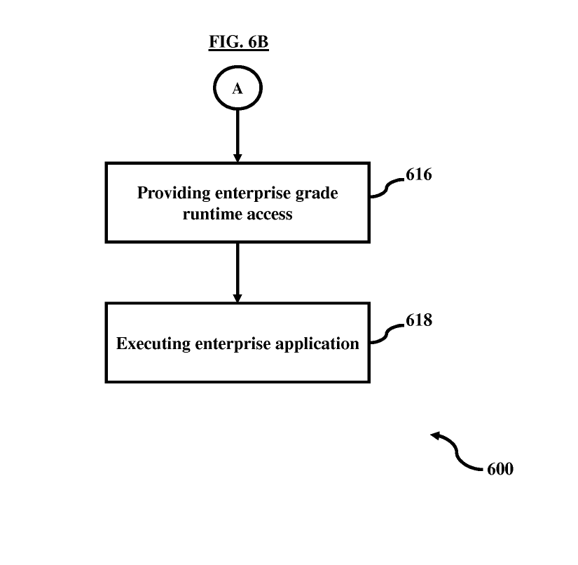

FIGS. 6A and 6B are flow diagrams which show various steps involved in the process of providing priority based resource access to enterprise applications, as disclosed in the embodiments herein.

When a user tries to run an application (say a ‘first application’) in the user device 100, an initialization request for running the application is received (602) by the enterprise grade runtime system 105 present in the user device 100. Now, the authentication module 302 of the enterprise application management module 201 checks (604) whether the first application is an authorized enterprise application (i.e., privileged enterprise application) or not. This checking can be done with the help of the registry database that present in the memory module 307. The registry database contains the list of all applications (along with their ID) that are registered as an enterprise application. The authentication module 302 confirms the first application as an authorized enterprise application or privileged application if the application is registered in the registry database of the memory module 307. If the ID of the application is not found in the registry database, the authentication module 302 treats the application as a ‘normal application’. Hence, no privilege is provided to access the enterprise grade runtime system 105. Then the application may be executed (606) normally with the available resources in the user device 100.

The registration of a particular application into the registry database can be made securely by using the public key (PuK) provided to the user (i.e., static method). The applications which are already installed in the user device 100 can also be registered as a privileged enterprise application by sending appropriate messages to the MDM client 202 present in the user device 100 (i.e., dynamic method). The messages (which are used to set a particular application as a privileged enterprise application) can be send through the remote MDM server 401 present in the enterprise grade runtime environment 400.

For example, let us consider a user tries to play music in his user device through the media player application. Let, the media player application is not an enterprise application or no privilege is provided for the media player application in the enterprise grade runtime system 105. So, when the user tries to run this application, the authentication module 302 checks whether the application requested to run is an authorized enterprise application or not. As there is no privilege for the media player application in the registry database, the application is executed normally with available audio ports in the user device 100.

If the application is an authorized enterprise application (i.e., privileged enterprise application), the tracking module 303 of the enterprise application management module 201 prepares the ‘resource availability list’ of the corresponding authorized enterprise application by fetching the resource list from the registry database in the memory module 307. In an embodiment, the resource availability list contains the details of resources required for the particular application, availability of the resources in the user device and the application which is currently using the corresponding resources. Further, the tracking module 303 checks (608) the availability of all resources required for the execution of the authorized enterprise application. This checking can be made with the help of ‘resource availability list’ made for the particular application.

If all the resources are available for the execution of the enterprise application, the application is executed (606) normally without providing any enterprise grade runtime access. If all the resources are not available (this condition arises if the required resources are being used by other applications of the user device 100, say ‘second application’), then the priority analyzer module 304 of the enterprise application management module 201 checks (610) the priority of the first application (i.e., privileged enterprise application) with the priority of the second application (application which is currently using the required resources). Then a comparison (612) is made between the priority levels of the first and second applications. If the first application has higher priority than the second application applications, the resource allocator module 305 provides (616) the enterprise grade runtime access to the first application.

In other case, if the priority of the first application is less than the priority of the second application, no access is provided to the first application to access the enterprise grade runtime system 105. Further, the first application waits (614) till the required resources are available (i.e., till the second application stops using the resources) to it. In another embodiment, the tracking module 303 continuously checks for the availability of the required resources. Once all the required resources are available, the first application is executed (606) normally in the user device 100.

For example, let us consider an application ‘X’ which is having privilege to access the enterprise grade runtime system is requested to run in the user device 100. Let, another application ‘Y’ is currently using some required resources which are required by the application ‘X’. Let, ‘X’ has high priority level and ‘Y’ has medium priority level. Now, the priority analyzer module 304 checks the priority of both the applications and since the application ‘X’ has high priority, the resource allocator module 305 assigns the required resources from application ‘Y’ to application ‘X’. Hence, application ‘X’ is executed without any interruption.

Once the enterprise grade runtime access is provided to the first application, the application is executed (618) as all the required resources (including the resources which are being used by second application) are available to it.

For example, let us consider an employee who is provided with the enterprise application on his user device tries to access the application. The enterprise application may require an access to audio as it may be an audio file or the like. During this, initially a check is made by the authentication module 302 to verify whether the application is authorized or not. After confirming it as an authorized application, the tracking module 303 prepares an availability list of resources by checking if there is any other file or application that is accessing the audio player. If there is some other audio file being played currently by any other application, then the priority analyzer module 304 analyzes the priority of the application that is currently accessing the audio player. If the application that is currently accessing the audio port is found to be a user level application or an enterprise application having a low priority value as compared to the one that is requesting resource access, the enterprise application is provided access to the desired resource i.e., audio player by pausing or terminating the other application that was accessing the audio player.

The various actions in method 600 may be performed in the order presented, in a different order or simultaneously. Further, in some embodiments, some actions listed in FIGS. 6A and 6B may be omitted.

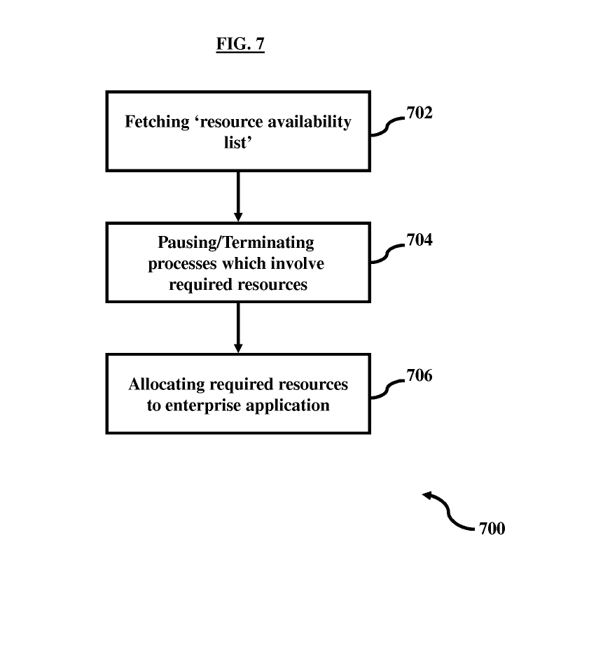

FIG. 7 is a flow diagram which shows various steps involved in the process of providing enterprise grade runtime access to a device application, as disclosed in the embodiments herein. When an enterprise application is provided with the enterprise grade runtime access, the resource allocator module 305 of the enterprise application management module 201 fetches (702) the resource availability list from the memory module 307 corresponding to the enterprise application that is to be executed.

Now, the resource allocator module 305 verifies the resource availability list and identifies the applications which are currently using the required resources. Further, the resource allocator module 305, allocates the required resources to the enterprise application by making them free from other applications which are currently using them. This can be done either by pausing (704) the applications or by terminating (704) the applications permanently. The term ‘pausing’ may refer to temporarily halting the process of the application; the term ‘terminating’ may refer to permanently killing the process of the application. In an embodiment, user can choose (either ‘pausing’ or ‘terminating’) this process while enumerating privileges in the enterprise grade runtime system 105. Later, the resource allocator module 305 allocates (706) the required resources (including the resources which are used by other applications) to the enterprise application which is further executed in the user device 100 without any interruption.

The various actions in method 700 may be performed in the order presented, in a different order or simultaneously. Further, in some embodiments, some actions listed in FIG. 7 may be omitted.

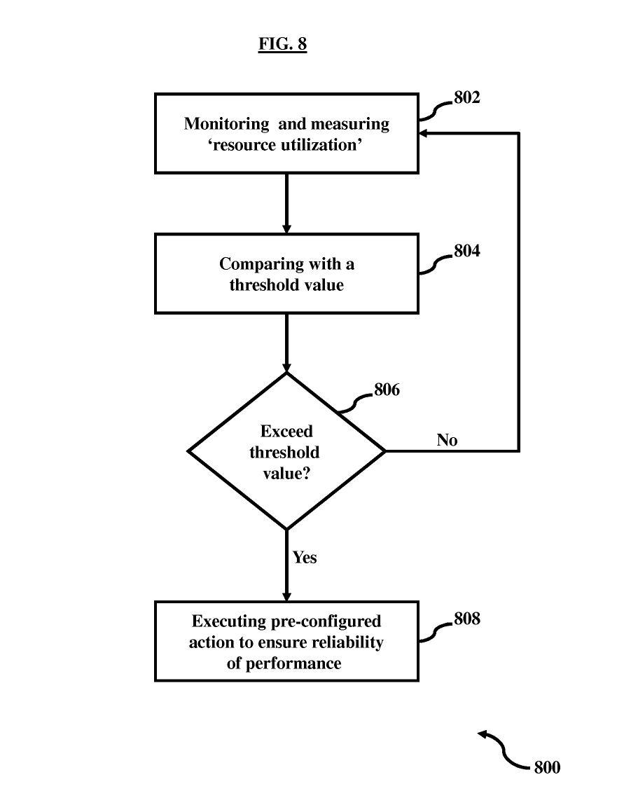

FIG. 8 is a flow diagram which shows various steps involved in the process of providing priority based resource utilization to enterprise applications, as disclosed in the embodiments herein.

For effective running of the enterprise applications in the user device 100, the resources which are required by the enterprise applications should be provided sufficiently based on the requirements of the enterprise applications. There may be situations where multiple applications are running simultaneously in the user device 100 utilizing the available resources simultaneously. Some of these applications may require more resources when compared with the other applications which are running in parallel in the application runtime environment. Due to this, the enterprise applications may not get sufficient resource access to run and may get terminated or slow down, which adversely affects throughput. Hence, the impact of such situations should be minimized to ensure reliable performance of enterprise applications in the application run time environment.

In order to utilize the resources effectively, the tracking module 303 of the enterprise application management module 201 continuously monitors and measures (802) the current utilization of resources in the user device 100. In an embodiment, information related to the resources which are to be monitored to measure utilization data may be selected and preconfigured with a database associated with the memory module 307. Further, the measured data are stored in the registry database of the memory module 307. Later, the priority analyzer 304 compares (804) the measured resource utilization value with pre-configured threshold value and checks (806) whether the current resource utilization value exceed the threshold value or not.

If the current resource utilization value is exceeded, this indicates a resource overloaded situation wherein the enterprise applications may not be getting sufficient resources as the resources are being utilized by the user level applications. So, the resource allocator module 305 executes (808) the pre-configured actions for optimal usage of resources among the enterprise applications. In an embodiment, the resource allocator module 305 pauses or terminates the user level applications (which are not registered as enterprise applications) to free resources and provides sufficient resource access to the enterprise applications. In case, if the enterprise application got terminated due to lack of sufficient resource access, it gets initialized or restarted by pausing or terminating other user level applications. In another embodiment, the priority analyzer 304 of the enterprise application management module 201, may log such failures either locally or communicate with the MDM server 401 present in the enterprise grade run time environment 400. It may also alert the end user about the application failure and restart. Moreover, the resource allocator module 305 retains the resource allocation to some required user level applications by checking with the registry database in the memory module 307.

In another embodiment, the threshold rules and values are pre-configured in the memory module 307 and are governed by various parameters such as maximum processor speed, memory, battery levels and power consumption of the communication device. If the measured resource utilization value is in limit with the pre-configured threshold value, no action is performed as the enterprise applications may get enough resources to run in the application run time environment.

The various actions in method 800 may be performed in the order presented, in a different order or simultaneously. Further, in some embodiments, some actions listed in FIG. 8 may be omitted.

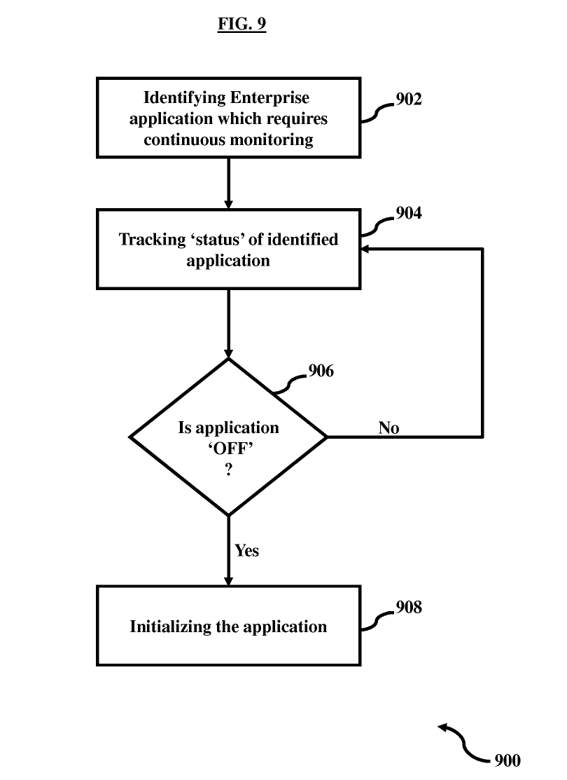

FIG. 9 is a flow diagram which shows various steps involved in the process of ensuring selected enterprise applications are always ON, as disclosed in the embodiments herein.

Some of the applications in the enterprise environment should always run in order to meet some enterprise requirements. Such applications are to be monitored continuously in the application runtime environment to ensure that they are always running (always ON).

The tracking module 303 of the enterprise application management module 201 identifies (902) the enterprise application which should always run by checking the ‘always on’ mode of the application in the registry database of the memory module 307. In an embodiment, this mode may be turned on by any authorized person, using corresponding options provided by the enterprise grade runtime system 105. If an enterprise application is in ‘always on’ mode, then that particular application should always run in the application runtime environment of the user device 100. When the tracking module 301 identifies the application which is in ‘always on’ mode, it further tracks (904) status of the application; wherein status indicates the current ON/OFF state of the application. Later, the priority analyzer module 304 checks (906) the status of the enterprise application. If the status of the enterprise application is OFF, then the resource allocator module 305 initializes or restarts (908) the enterprise application by providing access to required resources in the user device 100. For the applications which require user action (such as login details) may not recover fully. These applications can be restarted by providing required login details through the interface module 306. If the status of the enterprise is ON, no action is performed by the resource allocator module 305.

The various actions in method 900 may be performed in the order presented, in a different order or simultaneously. Further, in some embodiments, some actions listed in FIG. 9 may be omitted.

The following are some example embodiments (where the priority of applications is to be decided and access to resources is provided accordingly), in which the enterprise grade runtime system 105 can be used:

Consider a mission critical application requiring privileged access to GPS, data connectivity, messaging and call services. Such application executes as a background process monitoring and interacting with a interacting with a control center on the network. The periodic interactions must be reliable. The application requires a call setup akin to emergency calling which is invoked in critical situations. The call setup and audio control require privileged access.

MRM (Mobile Resource Management) Applications: Mobile Resource Management category applications are—data intensive and require high degree of reliability in a deployment. The end users of these applications work in varying network conditions due to high degree of mobility. The data collection and processing requires a highly reliable service for enterprise. The Software enterprise application management framework can ensure a high quality of data service and memory management support to the application to ensure that the application executes in a reliable and efficient environment.

The embodiments disclosed herein can be implemented through at least one software program running on at least one hardware device and performing network management functions to control the network elements. The network elements shown in FIG. 4 include blocks which can be at least one of a hardware device, or a combination of hardware device and software module.

The embodiment disclosed herein specifies a system for providing application management in a communication device using an enterprise grade runtime application. The mechanism allows priority value based application management in the communication device, providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for ensuring reliability of execution environment for a plurality of applications in a communication device, said method comprises of:
registering said plurality of applications as enterprise applications;
assigning priority value for each of said plurality of enterprise applications, wherein said priority value is indicative of criticality of at least one identified resource in said communication device in comparison with other enterprise applications requiring said at least one resource; and
managing each of said plurality of enterprise applications based on said assigned priority value.

2. The method as in claim 1, wherein said plurality of enterprise applications is registered as privileged applications.

3. The method as in claim 2, wherein registering said plurality of enterprise applications as privileged application involves defining specific rules and policies related to each of said plurality of enterprise applications.

4. The method as in claim 2, wherein said plurality of enterprise applications is registered as privileged applications statically.

5. The method as in claim 2, wherein said plurality of enterprise applications is registered as privileged applications dynamically.

6. The method as in claim 1, wherein said managing each of said plurality of enterprise applications involves providing priority based resource access to each of said plurality of enterprise applications.

7. The method as in claim 6, wherein said providing priority based resource access for said plurality of enterprise applications further comprises of:
analyzing an initialization request received from a first application of said plurality of applications;
checking a priority value of said first application on said first application being an enterprise application;
identifying at least one resource required for said first application to initialize;
comparing said priority value of said first application with that of a second application if said at least one resource is being used by said second application; and
providing access to said at least one resource for said first application on said priority value of said first application being more than that of said second application.

8. The method as in claim 7, wherein analyzing said initialization request comprises of authenticating signature of said first application.

9. The method as in claim 7, wherein said priority value is preconfigured.

10. The method as in claim 7, wherein identifying at least one resource required for said first application to initialize further comprises of:
fetching a unique id associated with said first application from said received initialization request; and
comparing said fetched Id with a database, wherein said database maps said plurality of applications with corresponding unique Id and resource requirements.

11. The method as in claim 1, wherein said managing each of said plurality of enterprise applications involves providing priority based resource utilization for said plurality of enterprise applications in said communication device.

12. The method as in claim 11, wherein providing priority based resource utilization for said plurality of enterprise applications in said communication device further comprises of:
monitoring and measuring resource utilization of at least one resource in said communication device;
comparing said measured resource utilization with a threshold value; and
triggering at least one pre-configured action if said measured resource utilization exceeds said threshold value.

13. The method as in claim 1, wherein said managing each of said plurality of enterprise applications involves ensuring that at least one selected enterprise application of said plurality of enterprise applications is always ON.

14. The method as in claim 13, wherein ensuring said at least one selected enterprise application of said plurality of enterprise applications is always ON further comprises of:
tracking status of said at least one enterprise application, wherein said status indicates ON or OFF state of said application; and
initializing said at least one enterprise application if said tracked status indicates OFF state.

15. A system for ensuring reliability of execution environment for a plurality of applications in a communication device, said system configured for:
registering said plurality of applications as enterprise applications using an enterprise grade run time system;
assigning priority value for each of said plurality of enterprise applications using said enterprise grade run time system, wherein said priority value is indicative of criticality of at least one identified resource in said communication device in comparison with other enterprise applications requiring said at least one resource; and
managing each of said plurality of enterprise applications based on said assigned priority value, using said enterprise grade run time system.

16. The system as in claim 15, wherein said enterprise grade run time system is further configured to register said plurality of enterprise applications as privileged applications.

17. The system as in claim 16, wherein said enterprise grade run time system is further configured to define specific rules and policies related to each of said plurality of enterprise applications while registering said plurality of enterprise applications as privileged applications.

18. The system as in claim 16, wherein said enterprise grade run time system is further configured to statically register said plurality of enterprise applications as privileged applications.

19. The system as in claim 16, wherein said enterprise grade run time system is further configured to dynamically register said plurality of enterprise applications as privileged applications.

20. The system as in claim 15, wherein said enterprise grade run time system is further configured to manage each of said plurality of enterprise applications by providing priority based resource access to each of said plurality of enterprise applications.

21. The system as in claim 20, wherein said enterprise grade run time system is further configured to provide said priority based resource access for said plurality of enterprise applications by:
analyzing an initialization request received from a first application of said plurality of applications using an enterprise application management module;
checking a priority value of said first application on said first application being an enterprise application using said enterprise application management module;
identifying at least one resource required for said first application to initialize using said enterprise application management module;
comparing said priority value of said first application with that of a second application if said at least one resource is being used by said second application using said enterprise application management module; and
providing access to said at least one resource for said first application using said enterprise application management module, if said priority value of said first application is more than that of said second application.

22. The system as in claim 21, wherein said enterprise application management module is further configured to analyze said initialization request by verifying authenticity of a signature associated with said first application.

23. The system as in claim 21, wherein said enterprise application management module is further configured to provide means for preconfiguring said priority value.

24. The system as in claim 21, wherein said enterprise application management module is further configured to identify said at least one resource required for said first application to initialize by:
fetching a unique id associated with said first application from said received initialization request using a tracking module; and
comparing said fetched Id with a database, wherein said database maps said plurality of applications with corresponding unique Id and resource requirements using said tracking module.

25. The system as in claim 15, wherein said enterprise grade run time system is further configured to manage each of said plurality of enterprise applications by controlling resource utilization in said communication device.

26. The system as in claim 25, wherein said enterprise grade run time system is further configured to control resource utilization in said communication device by:
monitoring and measuring resource utilization of at least one resource in said communication device using a tracking module;
comparing said measured resource utilization with a threshold value using a priority analyzer module; and
triggering at least one pre-configured action if said measured resource utilization exceeds said threshold value using a resource allocator module.

27. The system as in claim 15, wherein said enterprise grade run time system is further configured to manage each of said plurality of enterprise applications by ensuring that at least one selected enterprise application of said plurality of enterprise applications is always ON.

28. The system as in claim 27, wherein said ensuring said enterprise grade run time system is further configured to ensure that at least one selected enterprise application of said plurality of enterprise applications is always ON by:
tracking status of said at least one enterprise application using a tracking module, wherein said status indicates ON or OFF state of said application; and
initializing said at least one enterprise application using a resource allocator module if said tracked status indicates OFF state.
